(19) United States
(12) Patent Application Publication
(10) Pub. No.: US 2024/0119452 A1
(43) Pub. Date: Apr. 11, 2024

(54) DIGITAL MATERIAL UNITS CORRESPONDING TO AN IDLE CLAIM PARTITION FOR A DIFFERENTIATED MATERIAL EXTRACTION OPERATION

(71) Applicant: NETMEX GROUP LLC, Denver, CO (US)

(72) Inventors: Garrett Gissler, Denver, CO (US); Sean Smith, Denver, CO (US)

(21) Appl. No.: 18/378,817

(22) Filed: Oct. 11, 2023

Related U.S. Application Data
(60) Provisional application No. 63/415,050, filed on Oct. 11, 2022.

(51) Int. Cl. G06Q 20/40; G06Q 20/38

(52) U.S. Cl. CPC G06Q 20/401; G06Q 20/389

(57) ABSTRACT

There is disclosed a platform for providing an idle partition of a material extraction claim of a producer to multiple investors. The producer may operate according to differentiating practices with respect to conventional mines. This differentiation may be certifiable through third party metadata. The partition may be scheduled for future production on a material extraction date. The platform may include a transaction processor for processing transactions, a distributed ledger network (DLN) comprising multiple computational nodes connected to the transaction processor, and a producer ledger identically storing the transactions on all of the nodes. At least one digital material unit may be assigned to an investor in exchange for purchasing the future production of the idle partition. The platform may be configured to mint digital material units for trading among the multiple investors. Trading thereof may be allowed until the material extraction date. The third party metadata may include ESG certification.

### CROSS-REFERENCE TO PENDING PRIOR PATENT APPLICATION

This patent application claims the benefit under 35 U.S.C. 119 (e) of U.S. Provisional Patent Application No. 63/415,050, filed Oct. 11, 2022 by Garrett Gissler and Sean Smith for “Method of Creating Digital Units Corresponding to an Unmined Claim Partition for a Differentiated Mining Operation” which patent application is hereby incorporated herein by reference.

### BACKGROUND

Traditional investment offerings, like stock, bonds, loans, prepayment, and royalties from a production stream, may not sufficiently fund a material extraction operation owning land surface and subsurface mineral rights. Artificially low prices, the ‘boom and bust’ nature of commodities, and inflation can put junior producers out of business. Currently, metal and mineral ores, petroleum resources, gas resources, as well as surface water and groundwater may be decreasing in proven reserves, accessibility, and/or quality.

Institutions like the NYMEX, Chicago Board of Trade, and GLOBEX may aggregate an attractive, global pool of producers and investors for trading in minerals and metals futures. Commodity futures may be executable at some future date for an agreed upon price. Unfortunately, premium producers operating with values and practices additional to profit may not be distinguishable from conventional miners accepting lower prices, whereas certain ESG (environment, social, governance) practices may be more expensive to implement. As a result, premium producers may go out of business.

Additionally, the marketplace institutions may be centralized and thus lack transparency and be prone to fraud, or are easy targets for hacking. Futures contracts may be ‘double issued’ or offer ‘hypothetical assets’ not accountably collateralized. Further, the futures contracts may be limited to commodities already in production, or soon to be, and therefore exclude assets produced and available further out in time.

Platforms have existed to raise capital for funding production, such as ICOs (initial coin offering), IEOs (initial exchange offering), and STOs (security token offering). However, these existing distributed ledger network (DLN) or blockchain technology offerings may sell only the portions of the material extraction claim currently under production, leaving the producer underfunded. As used herein, a (natural) resource, such as a metal and mineral ore, liquid (petroleum, water, brine, etc.) resource, gas resource, or the like is referred to as a “material,” or the like.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is disclosed a method for providing multiple digital material units (dMUs) on a distributed ledger network (DLN) for a producer of a material extraction claim. At least one of the multiple dMUs may represent to an investor a future production of an idle partition of the claim. The dMU may be associable with real-time metadata differentiating the producer from conventional miners financed through centralized institutions. The DLN may store a producer ledger on multiple nodes comprising the DLN for verifying transactions and recording an ownership history of the dMU.

The method may further comprise identifying the idle partition having one or more of a GPS coordinate, subsurface materials data, and an extraction date for beginning the future production of the partition. The method may further comprise minting the dMU corresponding to the idle partition and attaching the real-time metadata and the GPS coordinate information, and other identifying information to the dMU. The method may further comprise updating the metadata periodically through a transaction processor interfacing with the DLN and accessible to the producer and the investor. The metadata may include one or more of the dMU ownership history, a current production report for the material extraction claim, an audit by a third party, and/or an ESG (environmental, social, governance) certification.

The method may further comprise listing the idle partition with a listing price, and may include approving by the producer a transaction requested by the investor for the idle partition. The method may further comprise transacting ownership of the dMU collateralized by the idle partition, and verifying by a majority of the multiple nodes of the network a legitimacy of the requested transaction. The DLN may be updated with a verified transaction. The method may further comprise updating the producer ledger with the verified transaction on all of the multiple nodes, where ownership of the dMU is frozen when the extraction date is reached.

In a further embodiment, there is disclosed a platform for providing to multiple investors an idle partition of a material extraction claim belonging to a commodities producer. The producer may operate according to differentiating values and practices with respect to conventional mines financed through a marketplace, which may be a centralized marketplace, and may include an over the counter (OTC) trading system, a peer to peer (P2P system) or other types of computer accessed systems. This differentiation may be certifiable through a third party metadata. The idle partition may be scheduled for future production starting on an extraction date.

The platform may further comprise a transaction processor for processing a commodities transaction through the internet and between various users of the platform, including the commodities producer, one of the multiple investors vetted by the platform, and various other users more fully vetted by the commodities producer. A distributed ledger network (DLN) may comprise multiple independent computational nodes distributed geographically and be connected to the transaction processor. A producer ledger may be identically storable on all of the multiple nodes for tracking the commodities transaction, and may assign at least one dMU to the one of the multiple investors in exchange for purchasing the future production of the idle partition.

The platform may be configured to mint the at least one dMU for trading by the multiple investors or known platform users, and the trading or resale thereof may be subsequently allowed until the extraction date. After reaching the extraction date, the platform may be receivable of, and the ledger appendable with, the third party metadata particular to the idle partition and may include one or more of a GPS coordinate, subsurface materials quality and/or quantity data, ESG (environment, social, governance) certification, audit of deposits, and mineral rights claims.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates a system block diagram of an example environment, wherein some embodiments of the present systems and methods of providing digital material units for a producer of a material extraction claim may be practiced.

FIG. 2 illustrates a diagram of an example material extraction claim for digital material units for a producer of a material extraction claim, in accordance with at least one embodiment of the present disclosure.

FIG. 3 illustrates a flowchart of creating and providing digital material units for a producer of a material extraction claim, in accordance with at least one embodiment of the present disclosure.

FIG. 4 illustrates a “forward sell” scenario of a digital material unit in accordance with at least one embodiment of the present disclosure.

FIG. 5 illustrates a scenario for sell of a previously acquired digital material unit (prior to the start of extraction), in accordance with at least one embodiment of the present disclosure.

FIG. 6 illustrates a scenario for producer material extraction of a digital material unit claim, in accordance with at least one embodiment of the present disclosure.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

As may be appreciated, based on the disclosure, there exists a need in the art for digital material unitizing the production of specific material extraction partitions schedulable for production at some future date. Also, there exists a need in the art for differentiating premium producers from conventional miners using high quality data, which may include real-time data or other types of collected data, for highlighting values and practices which cost more to implement. Additionally, there exists a need in the art for verifying the transactions, tracking asset ownership, and certifying the premium practices. Additionally, there exists a need for a new form of funding natural resource capital projects and development efforts different from traditional funding methods currently available to natural resource producers. Current Distributed Ledger Network (DLN) and blockchain technologies, as implemented, do not have adequate technological solutions to provide digital material unitizing the production of specific material extraction partitions schedulable for production at some future date. Nor do existing DLN and blockchain technologies have adequate technological solutions to differentiate premium producers from conventional miners using high quality data, which includes real-time metadata or other types of collected data, for highlighting values and practices which cost more to implement. Additionally, current DLN and blockchain technologies do not provide adequate technological solutions to verify the transactions, track asset ownership, and certify the premium practices. Embodiments of the present systems and methods provide a new form of funding natural resource capital projects and development efforts using DLN and blockchain technologies different from traditional funding methods currently available to natural resource producers.

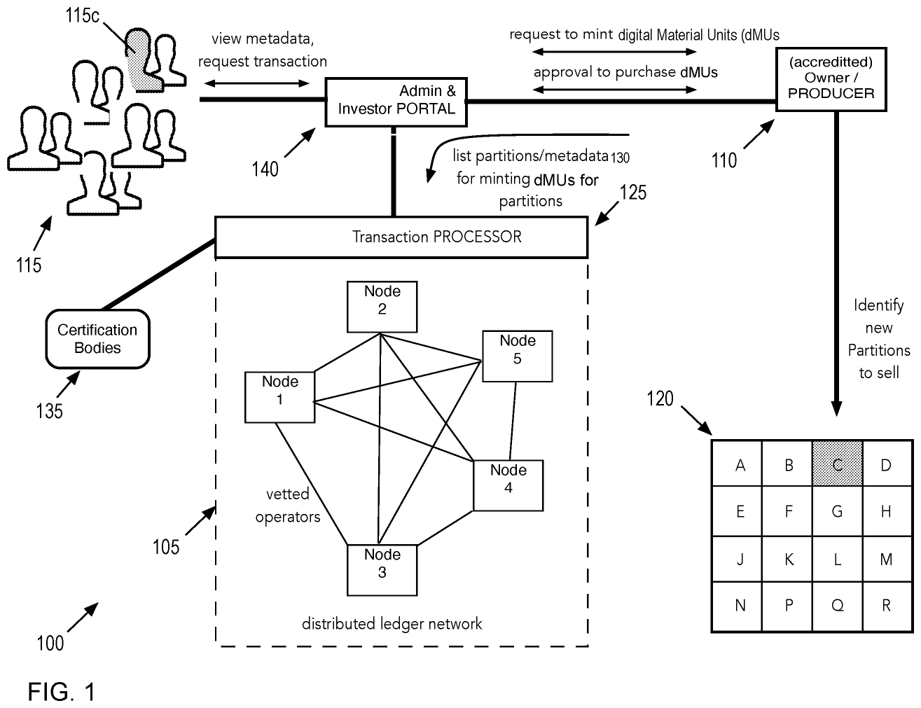

Referring now to FIGS. 1 through 3, in various embodiments, method 300 and platform environment 100 are described for providing multiple digital material units (dMUs) on DLN 105 for producer 110 of material extraction claim (land and/or sub-surface rights) 200 at least one of the multiple dMUs may represent to an investor (115) a future production of an idle partition (one of partitions 120A through 120R) of material extraction claim 200, which the producer wants to finance. The future production may be a commodity such as a refined metal, a refined mineral, rock and/or earth partition (section of earth), oil, gas, water, brine, or the like. Digitally unitizing the idle partitions may occur on a digital platform having transaction processor 125 for processing commodities transactions between the producer and multiple investors. The DLN may connect to the transaction processor and may comprise multiple independent computational nodes distributed geographically. The DLN may verify a legitimacy of a requested transaction by a consensus of or by a majority vote among of the decentralized multiple nodes. In various embodiments, processor 120 manages the ownership of the dMUs on the DLN 105 on the user's behalf.

DLN 105 may host a producer ledger identically storing and tracking, on (all of the) multiple nodes, the commodities transactions, associated dMUs, and an ownership history for each dMU. At least one dMU may be assigned to one of the multiple investors (115) in exchange for purchasing the future production of the idle partition (120). In addition, real-time metadata 130 may be collected by the platform and may be associated with each transaction for differentiating the material extraction practices of the producer from those of conventional miners. The real-time metadata may certify that the values and practices of producer 110 merit a higher price or value than investment offerings by the conventional miner. In accordance with various embodiments, the producer defines the details of the forward production contract and collateralized asset for initial dMU minting process. Table 1 shows metadata associable with digital material units for a producer of a material extraction claim, in accordance with example embodiments of the present systems and methods. Unchangeable hashed details included in the metadata of the dMU may include:

TABLE 1
UNCHANGEABLE HASHED DETAILS INCLUDED
IN THE METADATA OF A dMU

Materials contained and the quantity and quality of the material to be delivered.
Global Positioning System (GPS) coordinates that define the volume and exact
location of the collateralized asset from which the deliverable material is to be
produced.
Legal documents under the appropriate jurisdiction and legal system/framework
that entitle the dMU owner to the material produced from the producer's land
partition defined above.
Material grade(s), tonnage or volume, reserve certainty.
The material's initial or current dMU listing prices and current external market
prices of the associated materials represented by the dMU.
Scheduled production date, and other details pertinent to adequately describe the
assets perceived value.
A producer-user's demonstrated financial commitment to a project combined with
a demonstrated intent to produce the reserves to the market and deliver their
product to the dMU owner.

Continuing with FIG. 1 and Table 1, in various embodiments, real-time metadata may comprise periodic certifications received from third party organizations independent of the producer, such as any various ESG (environment, social, governance), production quality, or worker safety, related certification. Such metadata may highlight material extraction practices which some investors are willing to pay a premium price for, and which practices may be more costly to implement. Certifications may be provided by a certifying body 135 and may report a degree of compliance with local, national, or global standards for environmental protection, fair labor standards, safety standards, and/or product quality standards governance that includes all stakeholders, and/or the like. Examples of the certifying body may be a government regulator, a non-governmental organization (NCO), an industry trade association, community stakeholders, a consultant, or the like.

In one particular example, ESG certification may include data on one or more of water and effluents management, decarbonization, emissions, biodiversity, production input energy, waste materials (tailings), waste heat, ethical labor practices, fair trade practices, supplier assessments, independence from cartel influence, transparent internal governance, ethically sourced materials and the like. Real-time metadata may in some cases be provided internally (by the producer) when that data is only available from the producer, when that metadata is less critical for differentiating the material extraction practices of the operator, or the like.

Static metadata obtained during material extraction may also be associated with transactions for verifying a quality and/or a quantity of the future production (of the idle partitions), or the like, and may be internal (provided by the producer) or be provided by the third party. Static metadata may comprise one or more of one or more GPS coordinates, subsurface materials data, an audit of deposits, (a) material rights claim(s), and the like. As noted, Table 1 lists a number of metadata categories, which may be static (reported once or irregularly) or may be real-time (updated periodically or continuously). The listed metadata may be preferably supplied by third parties independent from the producer so as to generate trust in the producer for attracting a premium price for the dMUs, compared with conventional producers and offerings.

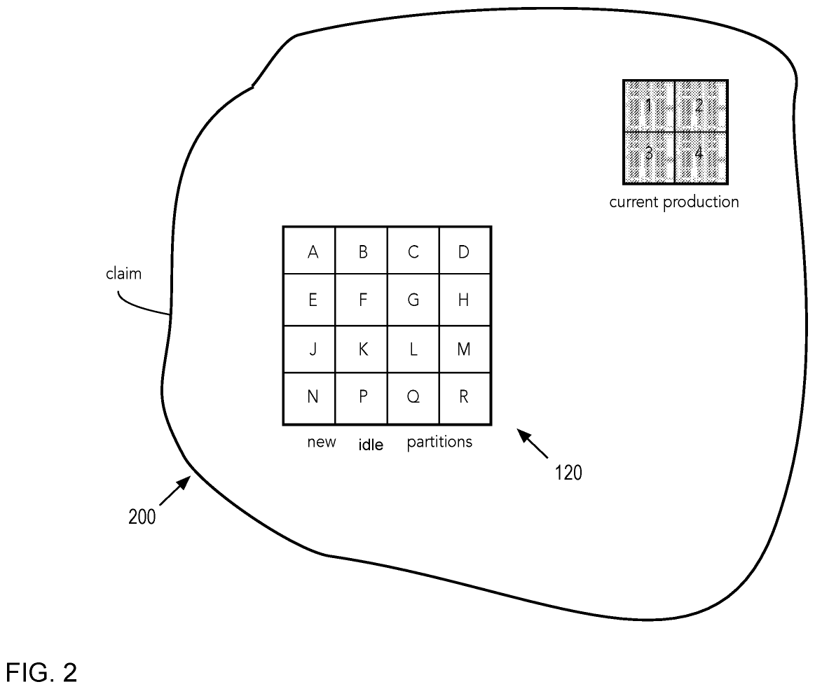

Returning to FIGS. 1 and 2, in various embodiments, the platform may include administrative and investor portal 140 interposed between the transaction processor and the investors and the producer for providing user-friendly access to the platform. The portal may be configured to receive a listing request from accredited producer 110 having identified a new batch of idle partitions (120A-R) to digital unitize. The platform may then approve the request to mint at least one dMU for each idle partitions to be traded by the multiple investors (110). The platform may have already accredited the producer to use the platform, by the producer meeting certain standards such as being the legal owners of the claim, verified as having the physical assets to be marketed, being financially stable, having active production operations, meeting the differentiating qualities that appeal to the investors the platform is configured to attract, and/or the like. For example, the platform may be tailored to host extraction operations that specialize in the ESG values and practices.

Continuing with FIGS. 1 through 2, in various embodiments, administrative and investor portal 140 may also be the access point for investors 115 interested in viewing investment opportunities and purchasing dMUs. Investors may be vetted to access the platform by meeting certain financial minimums, being willing and able to take delivery on the future production from the idle partition (120A-R), and/or other requirements that protect the security of the platform or ensure good alignment with the operation of the platform. In the example of FIG. 1, partition “C” may be of interest to investor 115c. The interested investor may request to purchase a dMU for the idle partition “C,” which may be sent to the producer for verifying the partition's availability and to approve the request. This request may occur within the platform or may occur outside of the platform or may involve a combination of actions both inside and outside of the platform.

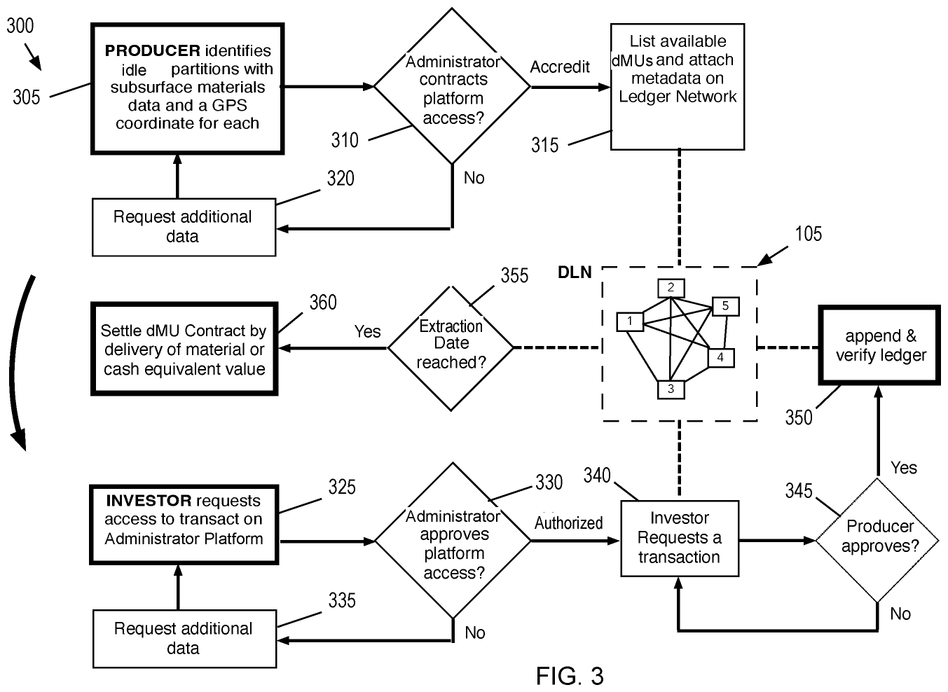

Referring now to FIGS. 1 through 3, in various embodiments, method 300, of FIG. 3 for digital unitizing of the idle partitions of the material extraction claim will now be described. The method may include identifying, at 305, by the producer, the idle partition having one or more of the GPS coordinates subsurface materials data, a material extraction date for beginning the future production of the partition, an/or the like. In the example of FIG. 1, sixteen (16) partitions (120A-R) have been identified. The GPS coordinate, materials data, the material extraction date, and/or the like may each be internal and static (not periodically updated) metadata provided by the producer, or may be provided by a third party if a more independent verification is desired. The subsurface materials data may include audited technical documents, which may include, but are not limited to, NI-43-101, SK-1300, JORC code, SAMREC code, and/or the like, for providing confidence that the deposit and material exist in adequate amounts to satisfy delivery terms.

Continuing, method 300 may include, at 310, minting the at least one dMU corresponding to the idle partition and attaching the real-time metadata and the GPS coordinate and partition to at least one dMU at 320. However, additional data may be requested, at 320, from the producer, prior to minting at 310 and 315. The method may further include updating the real-time metadata periodically, such as through the transaction processor, the metadata including one or more of the dMU ownership history, a current production report for the material extraction claim, an audit by the third party, the ESG (environmental, social, governance) certification, and/or the like, such as described above and below. The production report may include one or more of input materials, input energy/ton, material grade and tonnage or volume, output waste materials (tailings), output waste heat, and/or the like, and may be supplied by the producer or by an independent organization or certifying body (third party). The periodic updates to the metadata may be at least monthly for confirming the material extraction date and sustaining the differentiation of the producer.

The material extraction date may be updated periodically or automatically, based on an extrapolation of production reports from the producer, and may thus be considered real-time metadata. The information in the production report may indicate the success of the current material extraction operations and be extrapolated to suggest how credible is the material extraction date specified for the idle partition. The production report may also be useful for assessing compliance with the material extraction practices claimed by the operator for expecting a premium price for the commodity. The operator may choose how much real-time and static metadata to associate with the idle partition recorded in the producer ledger.

Referring still to FIGS. 1 through 3, method 300 may further include listing the idle partition with a listing price, at 315. Multiple investors may bid on the idle partition and may discover a transaction price through the transaction processor. The investor may request access to transact on the platform at 325, be authorized for platform use at 330 and any additional data to enable access requested at 335. At 340, the investor may request a transaction from the producer for the idle partition, and the producer may approve the requested transaction, at 345. Ownership of the at least one dMU, collateralized by the idle partition, may then be transacted by the transaction processor, at 350. In comparison, existing material extraction futures may be pooled over all producers and not linked to any particular asset, and therefore may be subject to fraud and the supply not guaranteed. Beneficially, the disclosed digital unitizing platform and method may provide a collateralized and verified investment, through the on-chain metadata, and/or the like.

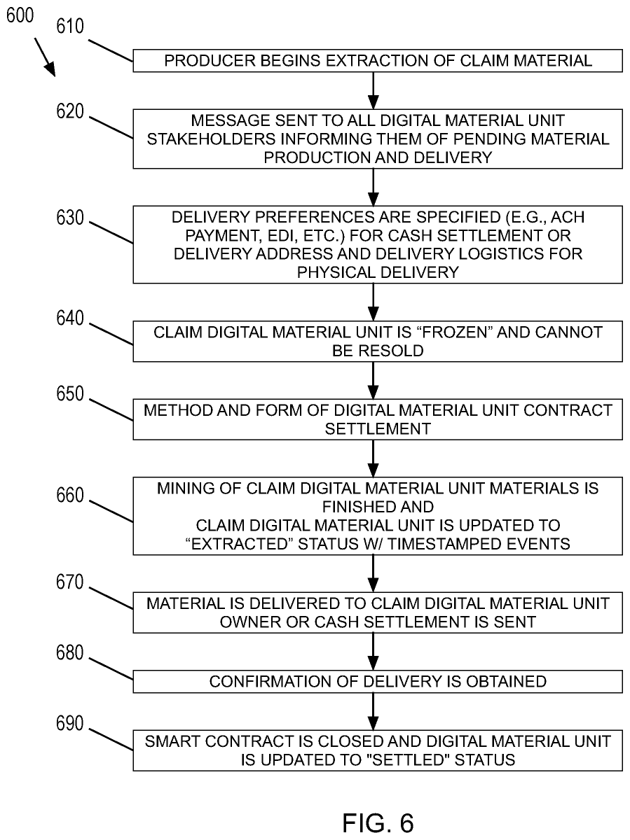

Continuing, method 300 may, at 350, further include verifying by a majority of the multiple nodes of the network a legitimacy of the requested transaction for updating the DLN with a verified transaction. The producer ledger may then be updated with the verified transaction on all of the multiple nodes for a secure and transparent appending including all current and past transactions. The ledger may also be appended with updates on one or more of the legal description(s), a material extraction date, a legal ownership of the material extraction claim, a material extraction rights subclaims, a land ownership contract, a reserve certainty, an audit of deposits, and/or the like. Additionally, the ledger may include materials data from jurisdictional disclosure standards such as NI-43-101, SK-1300, JORC code, SAMREC code, and/or the like, as appropriate for the material in question. Further trading may be allowed until the material extraction date. Once the material extraction date is reached, at 355, for each idle partition, ownership of the dMU is frozen and delivery arrangements are made (see description of FIG. 6 below). The future production may then be delivered, or the contract otherwise settled, at 360, to the investor holding the corresponding dMU.

Continuing with FIGS. 1 through 3, in various embodiments, each computational node may apply a hashing algorithm to the requested transaction, from 340 through 350, and may thereby calculate a transaction hash for comparison among all the nodes. An identical transaction hash among a consensus of the nodes may verify the legitimacy of the requested transaction and generate the verified transaction, from 350. Beneficially, since the transaction hash for any data string changes radically for small or large alterations in the string, violations of privacy or tampering are efficiently and reliably detected. Alternately, the verification among a majority of the nodes may be sufficient proof to update the producer ledgers on all of the nodes with the verified transaction, from 350. The approving of the requested transaction (e.g., at 345) may include a digital signature from each of the transacting parties and which may include the producer and the investor purchasing the at least one dMU.

In an embodiment not shown, the method may further include encrypting the producer ledger and providing the investor with a key, such as, as a result of acceptance of the transaction at 350, for accessing the producer ledger.

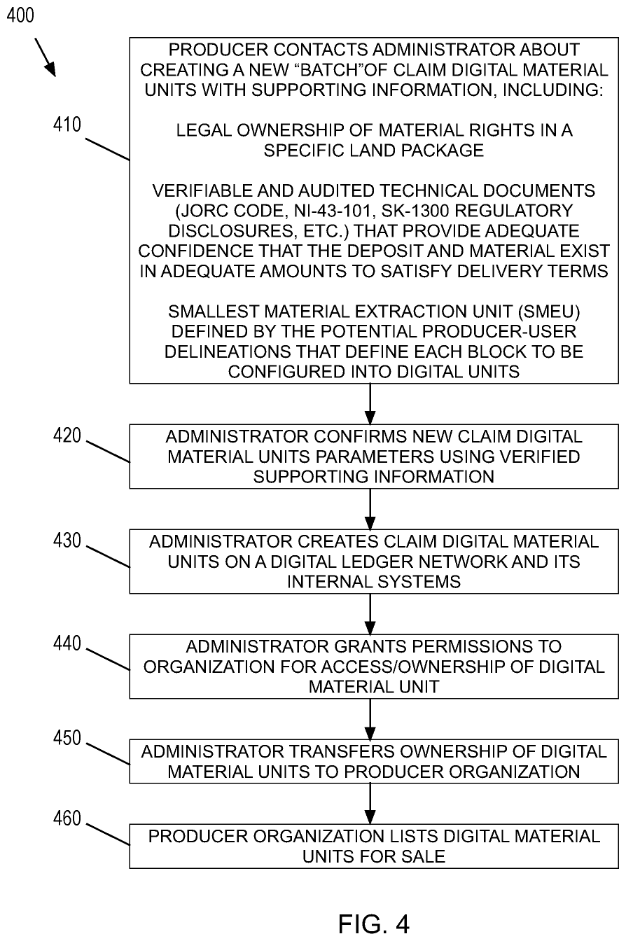

In various embodiments, FIGS. 4 through 6 describe transaction scenarios of the disclosed digital unitizing platform and method. FIG. 4 describes example series 400 of steps which may occur when a producer (110) of a material extraction claim 200) wishes to use the platform to mint dMUs for one or more idle partitions (120A through R, e.g., at 310 through 315), that is, when the producer wants to issue and “forward sell” a claim dMU. Therein, for example, at 410, the producer contacts the administrator about creating a new “batch” of claim dMUs with supporting materials, including, by way of example (at least): legal ownership of material extraction rights in a specific land package; verifiable and audited technical documents (e.g., NI-43-101, SK-1300, JORC code, SAMREC code regulatory disclosures, etc.), which provide adequate confidence that the deposit and material exist in adequate amounts to satisfy delivery terms; and Smallest Material Extraction Units (SMEUs) defined by the potential producer-user delineations that define each block to be configured into dMUs. The SMEU may be equivalent to each of the idle partitions (e.g., 120A through R) to be digital unitized. Once the platform (the platform administrator) has verified the supporting documentation, at 420, the platform may mint the dMUs, at 430, grant permissions to the producer for access and ownership, at 440, transfer ownership of the dMU to the producer at 450, and at 460 list (enable the producer to list) the dMUs for sale on the platform for investors to see.

In various embodiments, dMUs and claims may each have two unique IDs, an on-chain DLT assigned ID, and an administrator off-chain assigned ID. All dMU and claim associated metadata, as well as all events performed upon a dMU or claim, are logged and maintained by smart contracts on the DLT and on the administrator's off-chain copy and are publicly verifiable and can be queried.

Claim immutable metadata including contract details is cryptographically hashed by the administrator using encryption algorithms and set as a public metadata field upon claim creation as a hex string. Fields not required to be immutable for a claim are, in accordance with various embodiments, not included in the hash. dMUs do not require a cryptographic hash of metadata as all required immutable metadata may be maintained by the underlying smart contract. Validation of a claim hash and metadata may be performed by the administrator as well as by any third party by following the hash procedure defined by the administrator for a claim. dMU immutable data may be verified using the DLT's copy of the dMU and the DLT's copy of events for a dMU or the administrator's off-chain copy of a dMU and the administrator's off-chain log of events. The administrator maintains the source of truth for all IDs used in dMUs and claims, but the dMU immutable data maintained by the administrator's off-chain copy of the dMU and off-chain log of events can be verified using the DLT's copy of the dMU and the DLT's copy of events for the dMU.

The claim hash procedure is defined as:
hash the container dMU on and off-chain IDs;
hash off-chain administrator-issued claim ID;
hash off-chain administrator-issued source ID;
hash claim royalty amount;
hash claim location coordinates; and
hash all claim materials including:
   the off-chain administrator-issued material ID;
   material mass amount and unit; and
   material grade and unit.

In accordance with various embodiments, the administrator utilizes seven main transaction types: dMU creation, claim creation, dMU “Know Your Customer” (KYC) grant and/or revoke functions, dMU freeze and unfreeze for account, claim transfer, claim deletion, and dMU deletion.

The dMU creation may be the initial creation of the dMU smart construct on the DLT and on the administrator's off-chain copy (e.g., at 3XX/4XX). This transaction establishes source parameters for a dMU such as dMU name, dMU trading symbol, original issuer, and sets up all administrative rights for the administrator on the DLT.

The claim creation transaction may create each individual claim under an already existing dMU on the DLT and the administrator's off-chain copy. The claim immutable metadata fields may be hashed by the administrator and set as a public metadata field for a claim on the DLT and on the administrator's off-chain copy, which may be verified, as described above, using the on DLT version.

The dMU KYC grant/revoke transaction allows users to receive the administrator issued claims maintained by a container dMU. As a security feature, privileges to receive an administrator-issued claim must be explicitly granted by the administrator both on and off-chain. This transaction allows the administrator to ensure claims are only being transacted between authorized parties both on and off-chain, as well as enabling the administrator to grant and/or revoke privileges as required.

The dMU freeze/unfreeze for account transaction allows the administrator to prevent an account that has been granted KYC from receiving or sending the administrator-issued claims. The administrator can use this transaction during arbitration events or if external issues (legal or otherwise) deem it necessary to “freeze” the ownership of the administrator-issued claim until a resolution is reached. The administrator also uses this transaction in the event of a stolen or hacked account to prevent unauthorized third parties from transacting with the administrator issued claims.

The claim transfer transaction transfers ownership of a claim on the DLT and on the administrator's off-chain copy. The “to” account must, in accordance with embodiments herein, be granted KYC for a container dMU and both the “to” and “from” accounts must, in accordance with embodiments herein, not be frozen for a container dMU on the DLT and on the administrator's off-chain copy, before a transfer is allowed to go through. Ownership transfer transactions are settled on the DLT immediately (in under ten seconds), and are the only method of transferring a claim between accounts, in accordance with embodiments of the present systems and methods.

The claim deletion transaction allows the administrator to delete a claim and all its associated metadata from the container dMU. This transaction is only instituted when a claim has been mined, severed, drilled, extracted, processed or otherwise utilized, material has been delivered to the recipient account, and the recipient requests deletion of the claim record from the DLT, as well as the administrator's off-chain copy, or the recipient's account is closed.

The dMU deletion transaction allows the administrator to delete a dMU and all contained claims from the DLT as well as the administrator's off-chain copy. This transaction is only instituted in a material source account closeout.

In accordance with various embodiments, the administrator facilitates the liquidity of claims through a “buy now” functionality, or the like, where owners are able to place their claims for sale at a seller determined price. All secondary claim transfer transactions must, in accordance with such embodiments, be approved by the source producer who issued the claim. When a user issues a buy order for a claim on the portal, the administrator notifies the producer and seller that an open offer has been placed. If the source producer approves the transaction, funds are transferred and the buyer account is granted authorization and approval to purchase the container dMU and the claim is transferred to the buyer account. If a producer denies a transaction, the offer is closed and the claim may be relisted for sale so that a new transaction can take place. Claims can be bought and sold on the secondary market through the administrator until material extraction begins on a claim. When material extraction begins on the underlying assets of a claim, the producer will notify the administrator and the administrator will issue a freeze on a claim on the DLT, and on the administrator's off-chain copy, and notify all parties. The producer and claim receiving party will fulfill obligations of the claim contract and settle upon delivery of the asset. Upon delivery of the asset, the administrator will close the claim on the DLT and on the administrator's off-chain copy.

Events occurring hereunder, are, in accordance with embodiments of the present systems and methods, governed by the (respective) smart contract which incorporates all data, information, studies, location, rights, title, interest, obligations, representations, warranties, resale procedure, termination, and/or the like.

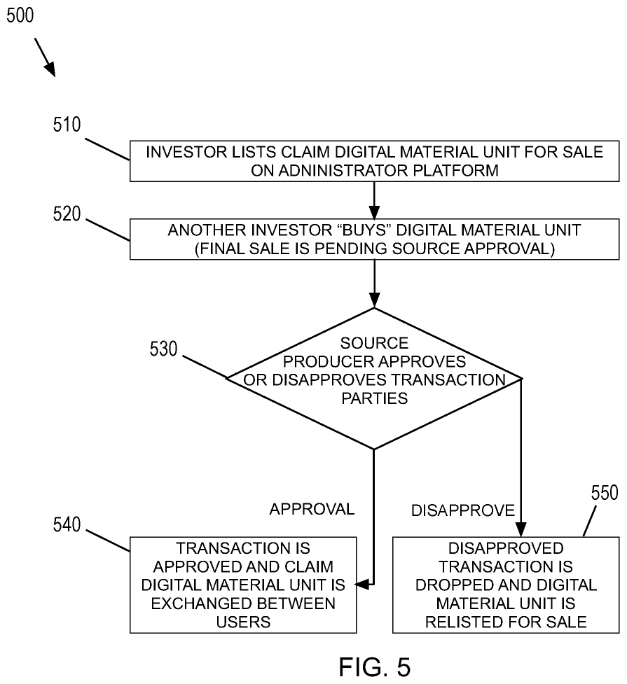

Digital material units may be listed for sale or may be negotiated and executed on the user's behalf by the platform based on direct negotiations between authorized users of the platform. For example, FIG. 5, is a flowchart showing sale 500 of a dMU from an investor, or the like, holding the dMU, in accordance with some embodiments. When, the investor holding a dMU with the producer may wish to sell that dMU, if the material extraction date has not been reached, (if producer has not started material extraction of the reserve block represented by the dMU), the investor may list the claim dMU for sale on the administrator platform, at 510. At 520, another investor, or the like, “buys” the dMU, however, final sale is pending original source producer approval. That is, the source producer may, in accordance with some embodiments, approve or reject the proposed sale (requested transaction) to another investor. Thus, at 530, the source producer approves or disapproves transaction parties. Upon producer approval at 530, the transaction is approved and claim dMU is exchanged between users, at 540. However, if the transaction is disapproved, by the producer at 530, the transaction is dropped and dMU is relisted for sale at 550.

FIG. 6, is a flowchart showing events 600 that occur when the producer “mines” a material claim dMU. The producer begins extraction of claim dMU materials at 610, at which time a message is sent to all dMU stakeholders informing them of pending material production and delivery, at 620. Delivery preferences are specified, at 630, including, by way of example ACH payment, Electronic Data Interchange (EDI), etc. from cash settlement, a delivery address and delivery logistics for physical delivery, or the like. At 640 the claim dMU is “frozen” (as described above) and cannot be resold. The method and form of dMU contract settlement is reached at 650. Once material extraction of the claim dMU materials is finished, the claim dMU is updated to “mined” status “extracted” status, or the like, with timestamped events, at 660. Material is delivered to claim dMU owner or cash settlement is sent at 670, and confirmation of delivery is obtained at 680. Then the dMU smart contract is closed and the dMU is updated to “settled” status, at 690.

Beneficially, the disclosed platform and method may provide and maintain an ecosystem for dMU transactions to take place, but without taking custody of any commodities in reserve. Producers may thereby effectively and efficiently fund their material extraction of metal and mineral ores, petroleum resources, gas resources, and water from surface and subsurface sources, and/or the like, within the existing markets. In addition to providing the dMUs, the producer may choose to make a payment from their current material extraction operation to the investor holding dMUs for one or more of the idle partitions.

In summary, the disclosed digital material unitizing platform may differentiate the producer's material extraction operation from conventional extraction operation s by 1) offering (dMUs) on the future production of physical assets, and by 2) tracking the physical commodities represented in the idle partitions. The producer may thereby attract funds for developing the material extraction claim through a pool of “buy-side” users authorized for accessing the platform. In comparison, traditional investment institutions may use antiquated technology and mindsets that lack transaction efficiency and transparency; paper futures contracts may be increasingly unmanageable. Market participants may question whether or not the traded futures are actually collateralized. For example, a single day's trading on the GLOBEX silver market may exceed annual silver production, suggesting that some of the commodity being sold doesn't actually exist. Recently, COMEX nickel contract validity has been questioned as some physical contract deliveries contained subpar, misrepresented, and/or counterfeit material.

Also, within traditional commodity exchanges, delivery of the commodity to the buyer may not be guaranteed when, for example, the COMEX or LME clearing houses can declare Force Majeure and settle the contract for cash. Advantageously, in accordance with embodiments herein an administrator's distributed ledger platform may instill (“re-instill”) heretofore lacking confidence in the purchase of (actual) future commodities. The platform may reduce a cyclicity in commodities pricing, reduce the risks of over/under supply, and reduce distortion in spot prices.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A method comprising:
identifying an idle partition of a material extraction claim having one or more of a Global Positioning System (GPS) coordinate, subsurface materials data, and a material extraction date for beginning future production of the partition;
minting at least one digital material unit corresponding to the idle partition on a distributed ledger network (DLN) and attaching real-time metadata and the GPS coordinate to the at least one digital material unit, the DLN storing a producer ledger on multiple nodes comprising the DLN for verifying transactions and recording an ownership history of the digital material unit;
updating the metadata periodically through a transaction processor interfacing with the DLN and accessible to the producer and an investor, the metadata including one or more of:
the ownership history of the digital material unit;
a current production report for the material extraction claim;
an audit by a third party; and
an environmental, social and governance certification;
listing the idle partition, on the DLN, with a listing price;
accepting approval by the producer of a transaction requested by the investor and for the idle partition;
transacting ownership of the digital material unit collateralized by the idle partition;
verifying by a majority of the multiple nodes of the DLN a legitimacy of the requested transaction for updating the DLN with a verified transaction;
updating the producer ledger with the verified transaction on all of the multiple nodes; and
freezing ownership of the digital material unit when the material extraction date is reached.

2. The method of claim 1, further comprising hashing, by each of the multiple nodes comprising the DLN, the requested transaction for accomplishing the verifying, the hashing producing a transaction hash that is identical for each of the majority of the nodes.

3. The method of claim 1, further comprising encrypting the producer ledger and providing the investor with access to the producer ledger.

4. The method of claim 1, further comprising delivering the future production to the investor when the material extraction date is reached.

5. The method of claim 1, wherein the material extraction claim is a land surface right and the future production is one of a refined mineral, a refined metal, a liquid and a gas.

6. The method of claim 1, further comprising updating the metadata through the transaction processor to include one or more of:
the material extraction date;
a legal ownership of the material extraction claim;
a material extraction rights subclaims;
a land ownership contract;
materials data;
a reserve certainty; and
an audit of deposits.

7. The method of claim 1, further comprising multiple investors attempting to purchase the idle partition and using setting a transaction price through the transaction processor.

8. The method of claim 1, further comprising paying, by the producer, a digital material unit redemption to the investor.

9. The method of claim 1, wherein the periodic updates to the metadata are at least monthly.

10. The method of claim 1, wherein the environmental, social and governance certification is independent of the producer and includes data on one or more of:
water and effluents management;
decarbonization;
emissions;
biodiversity;
production input energy;
waste materials;
waste heat;
ethical labor practices;
fair trade practices;
supplier assessments;
independence from cartel influence;
transparent internal governance; and
ethically sourced materials.

11. The method of claim 1, wherein the third party is independent of the producer and is one or more of:
a government regulator;
a non-governmental organization;
an industry trade association;
a community of stakeholders; and
a consultant.

12. The method of claim 1, wherein the production reports include one or more of:
input materials;
input energy per ton or volume;
material grade and tonnage or volume;
quantity and/or quality of output products;
output waste materials; and
output waste heat.

13. A platform comprising:
a transaction processor configured to process a commodities transaction through the internet and between a commodities producer and one of multiple investors vetted by the platform;
a distributed ledger network (DLN) comprising multiple independent computational nodes distributed geographically and connected to the transaction processor; and
a producer ledger identically storable on all of the multiple nodes, the producer ledger tracking the commodities transaction and assigning at least one digital material unit to the one of the multiple investors in exchange for purchasing future production of an idle partition of a material extraction claim belonging to a commodities producer;
the platform configured to:
mint the at least one digital material unit to be tradable by the multiple investors, the trading thereof subsequently allowed until the material extraction date; and
receive, and append to the ledger, third party metadata particular to the idle partition, the third party metadata comprising one or more of:
a GPS coordinate;
subsurface materials data;
an environment, social and governance certification;
an audit of deposits; and
material extraction rights claims.

14. The platform of claim 13, wherein the ledger is appended with internal metadata from the producer comprising:
real-time production reports when the producer is extracting material during the trading; and
a confirmation of the material extraction date.

15. The platform of claim 14, wherein the production reports are updated at least monthly and comprise one or more of:
input materials;
an input energy per ton or volume;
a material grade and tonnage or volume;
quantity and/or quality of output products;
output waste materials; and
output waste heat.

16. The platform of claim 13, wherein the platform is further configured to approve a listing request from the producer for minting the at least one digital material unit to be traded by the multiple investors.

17. The platform of claim 13, wherein the environmental, social and governance certification comprises data on one or more of:
water and effluents management;
decarbonization;
emissions;
biodiversity;
production input energy;
waste materials;
waste heat;
ethical labor practices;
fair trade practices;
supplier assessments;
independence from cartel influence;
transparent internal governance; and
ethically sourced materials.

18. The platform of claim 13, wherein the third party is independent of the producer and is one or more of:
a government regulator;
a non-governmental organization;
an industry trade association;
community stakeholders; and
a consultant.

19. The platform of claim 13, wherein the future production is one or more of a refined metal, a refined mineral, a processed rock, petroleum, refined petroleum products, other fossil fuels, water, brine, a liquid, and a gas.

20. The platform of claim 13, wherein the ledger is encrypted and the authorized investor is provided access the ledger.

21. A non-transitory computer-readable medium having program instructions stored thereupon, with upon execution by one or more processors cause the one or more processors to:
accept identification of an idle partition of a material extraction claim comprising one or more of a Global Positioning System (GPS) coordinate, subsurface materials data, and a material extraction date for beginning future production of the partition;
mint at least one digital material unit corresponding to the idle partition on a distributed ledger network (DLN) and attaching real-time metadata and the GPS coordinate to the at least one digital material unit, the DLN storing a producer ledger on multiple nodes comprising the DLN for verifying transactions and recording an ownership history of the digital material unit;
interface with the DLN and provide access to the producer and an investor;
update the metadata periodically, the metadata including one or more of:
the ownership history of the digital material unit;
a current production report for the material extraction claim;
an audit by a third party; and
an environmental, social and governance certification;
list the idle partition, on the DLN, with a listing price;
accept approval by the producer of a transaction requested by the investor and for the idle partition;
transact ownership of the digital material unit collateralized by the idle partition;
verify through a majority of the multiple nodes of the DLN a legitimacy of the requested transaction for updating the DLN with a verified transaction;
update the producer ledger with the verified transaction on all of the multiple nodes; and
freeze ownership of the digital material unit when the material extraction date is reached.
